(19) United States
(12) Patent Application Publication
(10) Pub. No.: US 2020/0186483 A1
(43) Pub. Date: Jun. 11, 2020

(54) MESSAGING APPLICATION WITH TIME-GATED ACCESSIBILITY

(71) Applicant: Dario Dara Alizad, Santa Monica, CA (US)

(72) Inventor: Dario Dara Alizad, Santa Monica, CA (US)

(21) Appl. No.: 16/708,385

(22) Filed: Dec. 9, 2019

Related U.S. Application Data
(60) Provisional application No. 62/777,003, filed on Dec. 7, 2018.

(51) Int. Cl. H04L 12/58; H04W 4/12; G06F 3/0488; G06F 3/0484; H04M 1/725; G06F 3/0481; G06F 3/0482

(52) U.S. Cl. CPC H04L 51/10; H04W 4/12; G06F 3/04883; G06F 3/0482; H04M 1/72547; G06F 3/04817; G06F 3/04842

(57) ABSTRACT

An messaging application for electronic devices that allows a sending user to time-gate messages so that a receiving user can only access the message after a specified amount of time has elapsed. When the specified amount of time has passed the receiving user can access the message which presents a reveal effect which may include, a graphic, an animation, text, an audible cue, a haptic cue, or a combination thereof.

### RELATED APPLICATION

This application claims the benefit of U.S. Provisional Application 62/777,003, filed on Dec. 7, 2018. The application referred to in this paragraph is incorporated herein as if set forth in its entirety.

### BACKGROUND OF THE DISCLOSURE

### Field of the Invention

The invention relates to mobile messaging applications and, more particularly, to messaging applications with time-gated accessibility to content of delivered messages.

### Description of the Related Art

Multimedia messaging on mobile devices and computer devices is ubiquitous. Indeed, in recent years “texting” has become the preferred mode of communication. Users are able to send not only text, but also photos, drawings, and sound recordings, and other multimedia files as attachments to a text message. Text messages and their associated attachments typically open as soon as the receiving user accesses the message with the user able to experience the attached multimedia content as soon as it downloads locally to the mobile device, which is usually a short delay of a couple of seconds.

Current messaging applications have several drawbacks and disadvantages. For example, they are limited in their ability to deliver a message that may only be accessed by the receiving user at a specified time or after a specified delay once the message is first accessed.

### BRIEF DESCRIPTION OF THE DRAWINGS

FIG. 1 shows a display screen of a message inbox with a graphical user interface on a mobile electronic device using the messaging application according to an embodiment of the present disclosure.

FIG. 2 shows a screenshot of a message composition screen with a graphical user interface on a mobile electronic device using the messaging application according to an embodiment of the present disclosure.

FIG. 3 shows a screenshot of a message view screen with a graphical user interface on a mobile electronic device using the messaging application according to an embodiment of the present disclosure.

FIGS. 4-6 show a series of screens illustrating an animated effect whereby a message is revealed with a graphical user interface on a mobile electronic device using the messaging application according to an embodiment of the present disclosure.

FIG. 7 shows a screenshot of a time-gate selection screen with a graphical user interface on a mobile electronic device using the messaging application according to an embodiment of the present disclosure.

### DETAILED DISCLOSURE

Certain aspects and advantages of the disclosure will become apparent from the following detailed description and the accompanying drawings which illustrate by way of example the features of the disclosure.

Relative terms used in the disclosure such as “inner”, “outer”, “upper”, “above”, “lower”, “beneath”, and “below”, and similar terms, may be used to describe a relationship of one graphic, object, or element to another. It is understood that these terms are intended to encompass different orientations and configurations of the devices, methods, and designs in addition to the orientations and configurations depicted in the figures.

Although the terms first, second, etc. may be used herein to describe various users, steps, elements, components, regions, layers and/or sections, these users, elements, components, regions, layers and/or sections should not be limited by these terms. These terms are only used to distinguish one user, step, element, component, region, layer or section from another. Thus, a first user, step, element, component, region, layer or section discussed below could be termed a second user, element, component, region, layer or section without departing from the teachings of the present disclosure.

Embodiments of the disclosure are described herein with reference to exemplary illustrations that, in some cases, are schematic illustrations of embodiments of the devices, methods, and designs of the present disclosure. As such, variations from the shapes of the illustrations such as, for example, customizations and optimizations are expected. Embodiments of the present disclosure should not be construed as limited to the particular shapes, sizes, designs, or layouts illustrated herein. Thus, the devices, methods, and designs illustrated in the figures are representative in nature and are not intended to unnecessarily limit the scope of the disclosure.

Embodiments of the disclosure include a messaging application accessible with mobile devices running a mobile application that allows a first user to send a time-gated message to an intended recipient or group of recipients. The receiving user(s) is informed of the time remaining before the message can be viewed and any attachment opened. When the message is revealed, the application provides a visually pleasing animation to reveal the message which may be accompanied by audible and/or haptic cues.

In one embodiment, a method of sending a time-gated message between electronic devices comprises the following steps. Input from a sending user via a first electronic device that defines a message is received, by a server, for example. Input from the sending user via the first electronic device that defines one or more receiving users is received. The sending user is provided with an option to time-gate the message. If the sending user opts to time-gate the message, input from said sending user via said first electronic device that defines a specified amount of time is received such that the one or more receiving users can only access the message after a specified amount of time has elapsed. The message is transmitted to one or more second electronic devices, each of the electronic devices associated with a respective one of the receiving users. A reveal effect is provided to the one or more receiving users as the message is revealed. And the message is presented to the one or more receiving users on the one or more second electronic devices.

It is also understood any of the methods disclosed herein may be recorded onto non-transitory computer readable storage medium storing one or more programs, the one or more programs comprising instructions, which when executed by an electronic device, cause the device to perform steps of the method.

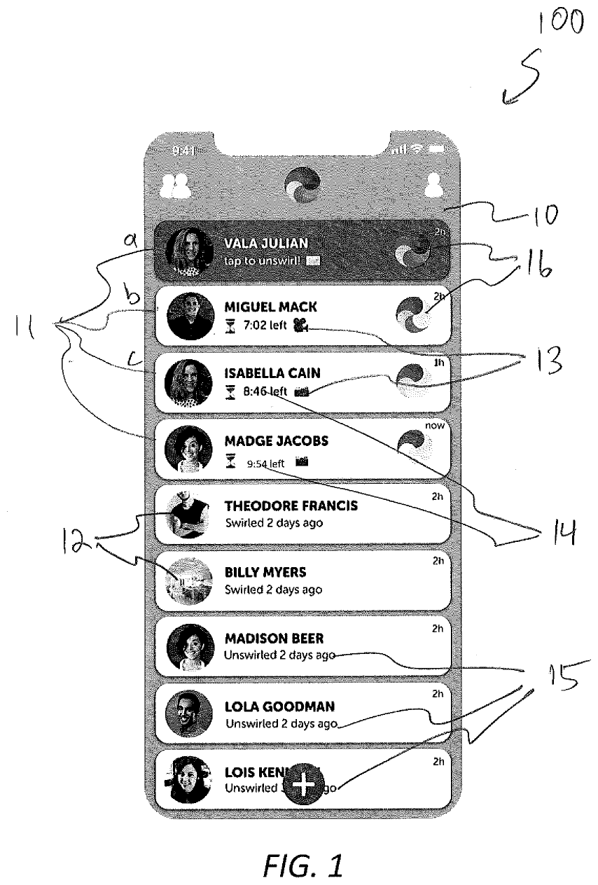

FIG. 1 is a screenshot from a mobile messaging application on a mobile device 100 according to the present disclosure. This particular screenshot shows a list of messages which have been received by a user. The messages can contain content including text, pictures, video, audio, combinations thereof, and other types of content. In the exemplary inbox shown in the display screen 10 of FIG. 1, an application user has received several messages 11 which populate the user's inbox. In this embodiment, each message 11 indicates information related to the message including the sending user 12, the type of message received 13, the time-gate information (if applicable) 14, and receipt information 15.

For example, with reference to FIG. 1, the exemplary user message 11a at the top of the list includes a text message (indicated by the envelope graphic) which was sent two hours prior (2 h), and the message 11a is ready to be viewed (indicated by the time-gate information “tap to unswirl!”). The swirl icon 16 shown at the right side of the message 10 provides a visual indicator of the time remaining before the message 10 can be viewed. In this embodiment, the swirl icon 16 is completely filled in, indicating that the message 10 is presently ready to be viewed.

In the exemplary message 11b second from the top of the list, the message 11b contains a video (indicated by the movie camera icon) which was sent two hours prior (2 h); however, this message 11b has been time-gated and is unavailable for review for another seven minutes and two seconds (indicated by the time-gate information which shows an hour glass graphic and the text “7:02”). The swirl icon 16 shown at the right side of the message 11b provides a visual indicator of the time remaining before the message 11b can be viewed. In this embodiment, the swirl icon 16 is about three quarters filled in, also indicating that the message 11b is not ready to be viewed.

In the exemplary message 11c third from the top of the list, the message 11c contains a picture (indicated by the camera icon) which was sent one hour prior (1 h); however, this message 11c has been time-gated and is unavailable for review for another eight minutes and forty-six seconds (indicated by the time-gate information which shows an hour glass graphic and the text “8:46”). The swirl icon 16 shown at the right side of the message provides a visual indicator of the time remaining before the message can be viewed. In this embodiment, the swirl icon 16 is less than half filled in, also indicating that the message 11c is not ready to be viewed.

In the exemplary message 11d fourth from the top of the list, the message 11d contains a picture (indicated by the camera icon) which was sent at the present time that the user is viewing the screen; however, this message 11d has been time-gated and is unavailable for review for another nine minutes and fifty-four seconds (indicated by the time-gate information which shows an hour glass graphic and the text “9:54”). The swirl icon 16 shown at the right side of the message 11d provides a visual indicator of the time remaining before the message 11d can be viewed. In this embodiment, the swirl icon 16 is less than half filled in, also indicating that the message 11d is not ready to be viewed.

The five messages at the bottom of the list have already been viewed by the receiving user. Those messages have been archived and are available for reviewing until they are deleted. The text beneath the sending user's name indicates when the message was “unswirled,” i.e., when the message was viewed by the receiving user.

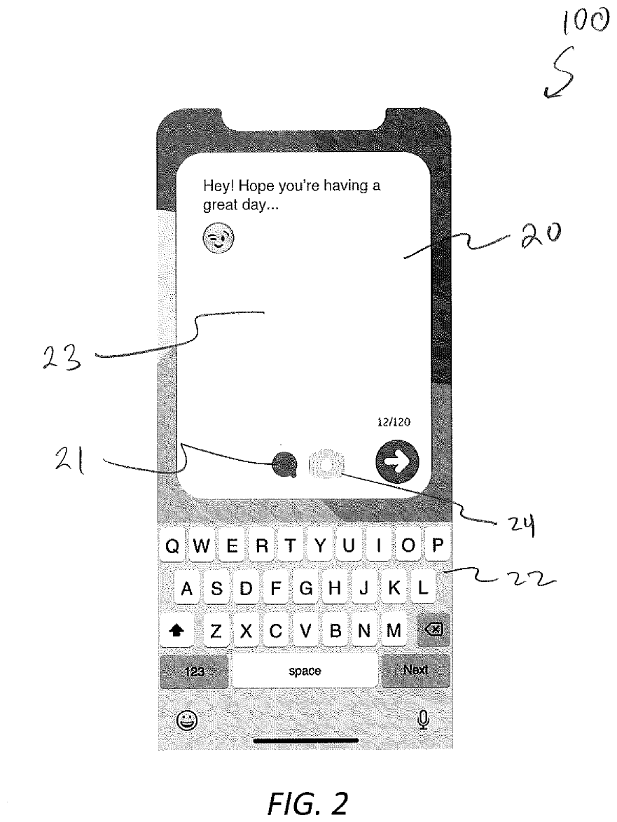

FIG. 2 shows a screenshot of a message composition screen 20. The sending user can compose a message consisting of text, pictures, video, audio, combinations thereof, and other types of content. The bubble icon button 21 allows the sending user to access the keyboard to write text into the message composition area 23. The camera icon button 24 allows the user to insert pictures or videos from the sending user's library into the message composition area 23. Once composed, the message may be sent to an intended receiving user. The message may be sent such that it may be viewed by the receiving user immediately, or it can be time-gated as described herein.

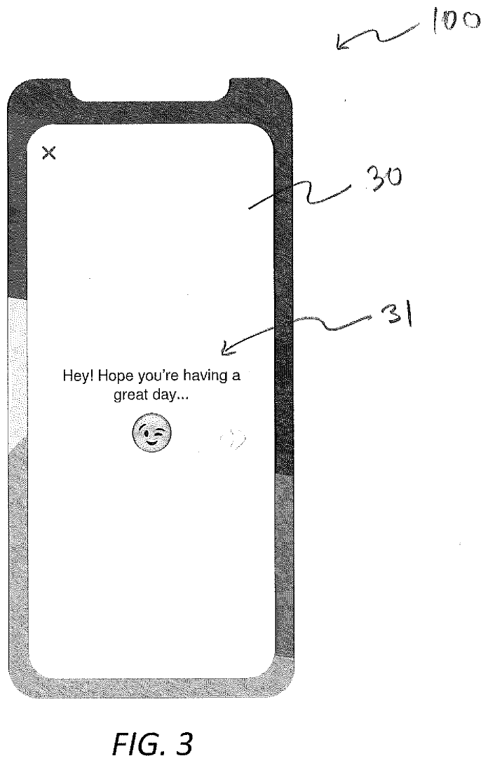

FIG. 3 shows a screenshot of a message view screen 30 wherein a receiving user has opened a message 31 that has been sent to it.

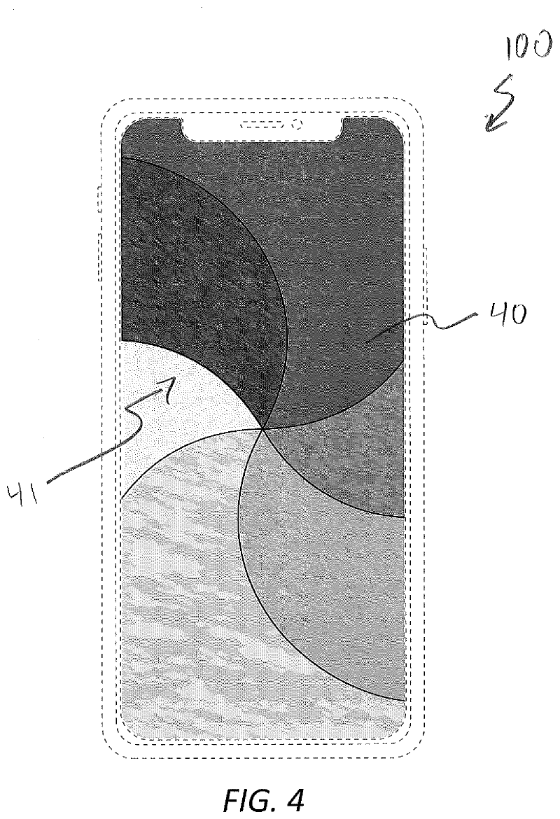

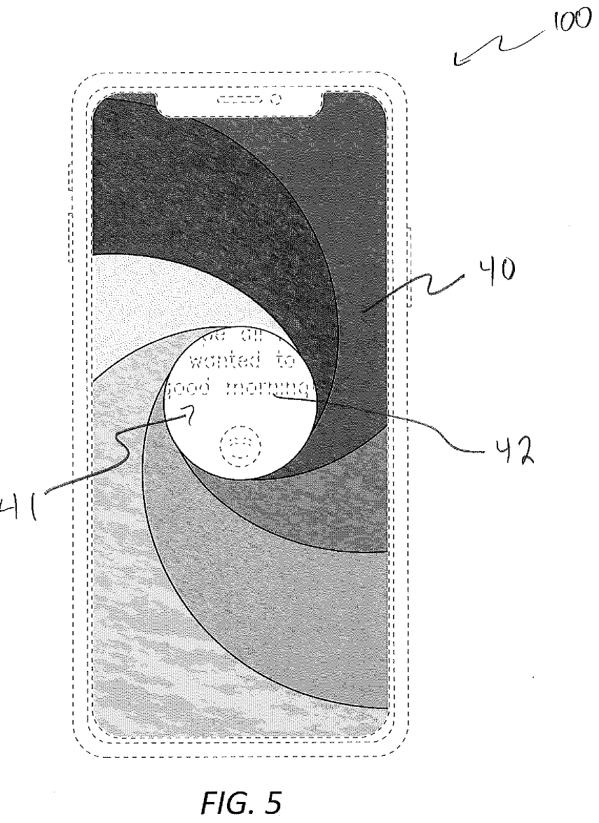

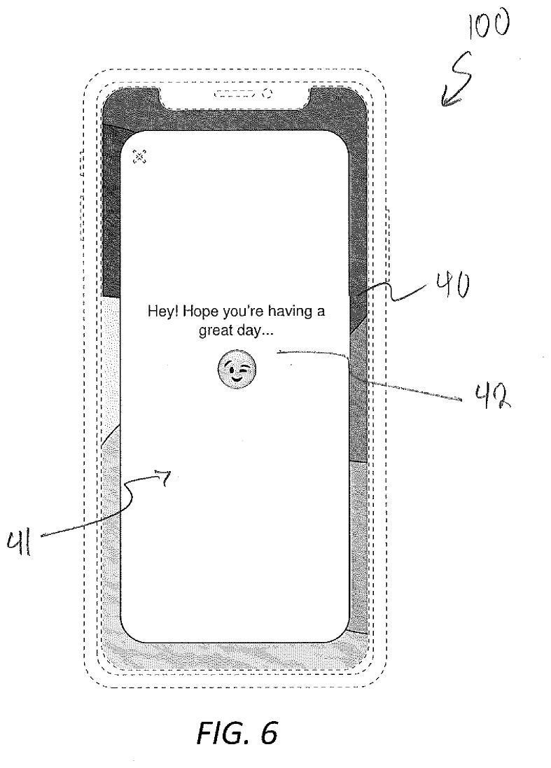

FIGS. 4-6 show a series of screens illustrating an animation effect whereby a message is revealed to a receiving user when the message is “unswirled.” The swirl graphic 40 initially covers the entire message area 41 as shown in FIG. 4. Gradually, the swirl graphic 40 unswirls to reveal the message 42 beneath. FIG. 5 shows the message area 41 partially unswirled, and the message 42 is partially revealed in the message area 41. FIG. 6 shows the message 42 in its entirety after if has been fully unswirled, i.e., the swirl graphic has been completely removed from the message area. The swirl graphic 40 shown in FIGS. 4-6 is merely exemplary. It is understood that many other animations may be used for the reveal feature. The reveal feature may also include audible and/or haptic cues. In some embodiments, the reveal effect includes an attachment cue indicating that the message includes multimedia content. Indeed, the attachment cue can even indicate what kind of multimedia content is attached. For example, if the multimedia content is a photo, then the reveal effect may include the sound of a camera shutter. The sending user may customize the reveal effect in many different ways.

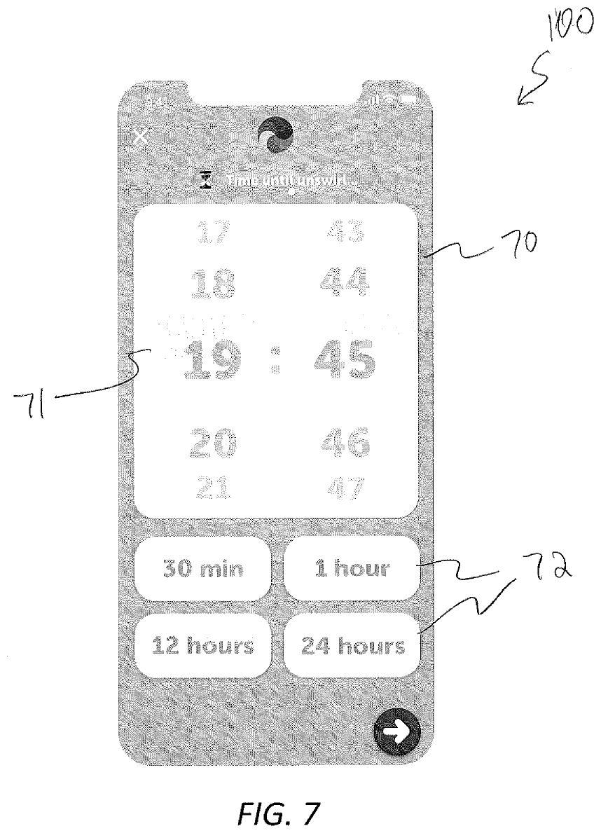

FIG. 7 shows a screenshot of a time-gate selection screen 70 wherein the sending user can choose an amount of time that the receiving user must wait once it receives the message before the message can be revealed. In this particular embodiment, the time-gate screen includes a time selector tool 71 that allows the sending user to specify the wait time as a custom time in hours and minutes, or the sending user can choose from several buttons 72 that display preset time amounts, e.g., 30 mins, 1 hour, 12 hours, or 24 hours. It is understood that other preset time units can also be used to set the wait time. Many different time-gate entry screens are possible.

Although embodiments of the present disclosure have been described in detail with reference to certain preferred configurations thereof, other versions are possible. Any of the features of the devices, methods, and designs described herein can be used in combination with any of the other features described herein. The spirit and scope of the disclosure should not be limited to the versions described above.

We claim:

1. A method of sending a time-gated message between electronic devices, comprising:
receiving input from a sending user via a first electronic device that defines a message;
receiving input from said sending user via said first electronic device that defines one or more receiving users;
providing said sending user with an option to time-gate said message;
if said sending user opts to time-gate said message, receiving input from said sending user via said first electronic device that defines a specified amount of time such that said one or more receiving users can only access said message after a specified amount of time has elapsed;
transmitting said message to one or more second electronic devices, each of said electronic devices associated with a respective one of said one or more receiving users;
providing a reveal effect to said one or more receiving users as said message is revealed; and
presenting said message to said one or more receiving users on said one or more second electronic devices.

2. The method of claim 1, wherein said reveal effect comprises a graphic, an animation, text, an audible cue, a haptic cue, or a combination thereof.

3. The method of claim 1, wherein said reveal effect comprises an animation effect wherein said display screen appears to unswirl to reveal said message.

4. The method of claim 3, wherein said animation effect is accompanied by an audible effect.

5. The method of claim 3, wherein said animation effect is accompanied by a haptic effect.

6. The method of claim 1, wherein said sending user is provided with one or more preset values for said specified amount of time.

7. The method of claim 1, wherein said reveal effect comprises an attachment cue indicating that said message includes multimedia content.

8. The method of claim 8, wherein said attachment cue is different for each type of multimedia attachment.
